(19) United States
(12) Patent Application Publication
(10) Pub. No.: US 2003/0093538 A1
(43) Pub. Date: May 15, 2003

(54) Information device, information distribution system, and communication mode switching method, information storage method and information distribution method applied thereto

(76) Inventor: Takayasu Tsuchiuchi, Fuchu-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/233,583

(22) Filed: Sep. 4, 2002

(30) Foreign Application Priority Data
Nov. 14, 2001 (JP) 2001-348914

(51) Int. Cl. G06F 15/16

(52) U.S. Cl. 709/229

(57) ABSTRACT

An information device is capable of receiving information distributed from devices via a short-range wireless communication device and make switching between a first communication mode in which all of push requests of information from unspecified devices which lie within a communicable range are received and a second communication mode in which only push requests of information from devices each having previously registered identification information are received and push requests from the other devices are refused. The communication mode switching operation is instantly performed by use of a communication mode selection switch used as a hardware which the user can operate in one operation.

### CROSS-REFERENCE TO RELATED APPLICATIONS

This application is based upon and claims the benefit of priority from the prior Japanese Patent Application No. 2001-348914, filed Nov. 14, 2001, the entire contents of which are incorporated herein by reference.

### BACKGROUND OF THE INVENTION

1. Field of the Invention

The present invention relates to an information device and information distribution system which can receive information distributed from another device via a communication device, and a communication mode switching method, information storage method and information distribution method applied thereto.

2. Description of the Related Art

Recently, information devices having short-range wireless communication devices uses short-range wireless communication technology, such as Bluetooth™, are being sold. The short-range wireless communication device is realized, e.g., in the form of a PC card or SD card and they are inserted into the information device.

As one communication form of the information device using the short-range wireless communication device, there is provided a form of receiving push-type (or insertion type) distribution information from another device.

On the information device side which performs push-type information distribution, information is actively distributed to another devices which lie within a communicable range. On the other hand, the information device which receives push-type distribution information passively receives a push request of information from another device and stores received information into a preset storage area.

Since distributed information can be smoothly fetched by information devices which lie within a communicable range, the push-type information distribution is a distribution form which is highly valuable for those which perform information distribution.

However, since the information device which receives push-type distribution information passively receives information containing a push request particularly without refusing the information, there is a possibility that information may flow into the memory endlessly. Therefore, in the memory of the information device which receives push-type distribution information, a large amount of unnecessary information is stored in addition to necessary information and there thus occurs a problem of information management.

Further, if information flows into the memory endlessly, the capacity of information to be stored instantly reaches an upper limit and information is sequentially erased starting from the oldest information, which means that information important for the user may sequentially be erased.

If a method for one-sidedly rejecting the push request of distributed information is used, the above advantage of the push-type information reception will be lost.

### BRIEF SUMMARY OF THE INVENTION

Embodiments of the present invention provide an information device and information distribution system which can efficiently receive distribution information from another device, and a communication mode switching method, information storage method and information distribution method which can be applied to the above devices.

According to an aspect of the present invention, there is provided an information device for receiving information distributed from devices via a communication device, comprising a communication mode selection switch configured to allow switching between a first communication mode for receiving an information distribution request from an arbitrary device and a second communication mode for receiving an information distribution request from a device having specified identification information; and a control unit configured to perform a switching control to set one of the first and second communication modes in accordance with a switching operation of the communication mode selection switch.

According to another aspect of the present invention, there is provided an information distribution system comprising an information distribution device configured to perform information distribution; and an information device configured to receive information distributed from the information distribution device via a communication device, the information device including a communication mode selection switch configured to allow switching between a first communication mode for receiving an information distribution request from an arbitrary device and a second communication mode for receiving an information distribution request from a device having specified identification information, and a control unit configured to perform a switching control to set one of the first and second communication modes in accordance with a switching operation of the communication mode selection switch.

According to still another aspect of the present invention, there is provided a communication mode switching method applied to an information device for receiving information distributed from devices via a communication device, comprising allowing a switching operation between a first communication mode for receiving an information distribution request from an arbitrary device and a second communication mode for receiving an information distribution request from a device having a specified identification information, via a communication mode selection switch; and setting one of the first and second communication modes in accordance with a switching operation of the communication mode selection switch.

According to still another aspect of the present invention, there is provided an information distribution method applied to a system in which an information device receives information distributed from an information distribution device via a communication device, comprising allowing a switching operation between a first communication mode for receiving an information distribution request from an arbitrary device and a second communication mode for receiving an information distribution request from a device having a specified identification information, via a communication mode selection switch, on the information device; and performing information distribution from the information distribution device to the information device while the first communication mode is set by use of the communication mode selection switch.

According to still another aspect of the present invention, there is provided an information device for receiving information distributed from devices via a communication device, comprising a communication mode selection switch configured to allow switching between a plurality of communication modes for receiving information distribution requests, one of the plurality of communication modes being a mode for receiving an information distribution request from a device having specified identification information; and a control unit configured to perform a switching control to set one of the plurality of communication modes in accordance with a switching operation of the communication mode selection switch.

According to still another aspect of the present invention, there is provided a communication mode switching method applied to an information device for receiving information distributed from devices via a communication device, comprising allowing a switching operation between a plurality of communication modes for receiving information distribution requests, one of the plurality of communication modes being a mode for receiving an information distribution request from a device having a specified identification information, via a communication mode selection switch; and setting one of the plurality of communication modes in accordance with a switching operation of the communication mode selection switch.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for illustrating wireless communication between an information device (portable information terminal) according to one embodiment of the present invention, and other devices;

FIG. 2 is a view for illustrating push-type information distribution with respect to the information device (portable information terminal);

FIGS. 3A and 3B are views for illustrating one example (slide switch) of a communication mode switching mechanism to make switching between first and second switching modes in the information device (portable information terminal);

FIGS. 4A and 4B are views showing two states into which the slide switch can be set;

FIGS. 5A and 5B are views for illustrating another example (button switch) of the communication mode switching mechanism to make switching between the first and second switching modes in the information device (portable information terminal);

FIGS. 6A and 6B are views showing two states into which the button switch can be set;

FIG. 7 is a view for illustrating an example in which the information device is a headphone type music playback device;

FIG. 8 is a view for illustrating one example (slide switch) of a communication mode switching mechanism to make switching between first and second switching modes in the information device (music playback device);

FIG. 9 is a view for illustrating another example (button switch) of the communication mode switching mechanism to make switching between the first and second switching modes in the information device (music playback device);

FIG. 10 is a view showing a musical composition sales terminal which distributes musical compositions to a music playback device;

FIG. 11 is a block diagram showing the configuration of the music playback device and musical composition sales terminal;

FIG. 12 is a view showing a state in which the owner of the music playback device performs an operation for purchasing a musical composition with respect to the musical composition sales terminal;

FIG. 13 is a diagram for illustrating a recording space used to record information which the information device such as the portable information terminal or music playback device acquires from another device;

FIG. 14 is a flowchart for illustrating the operation of the information device; and

FIG. 15 is a flowchart for illustrating the operation performed when a musical composition is purchased from the musical composition sales terminal by use of the music playback device.

### DETAILED DESCRIPTION OF THE INVENTION

Embodiments of the present invention will be described below with reference to the drawings.

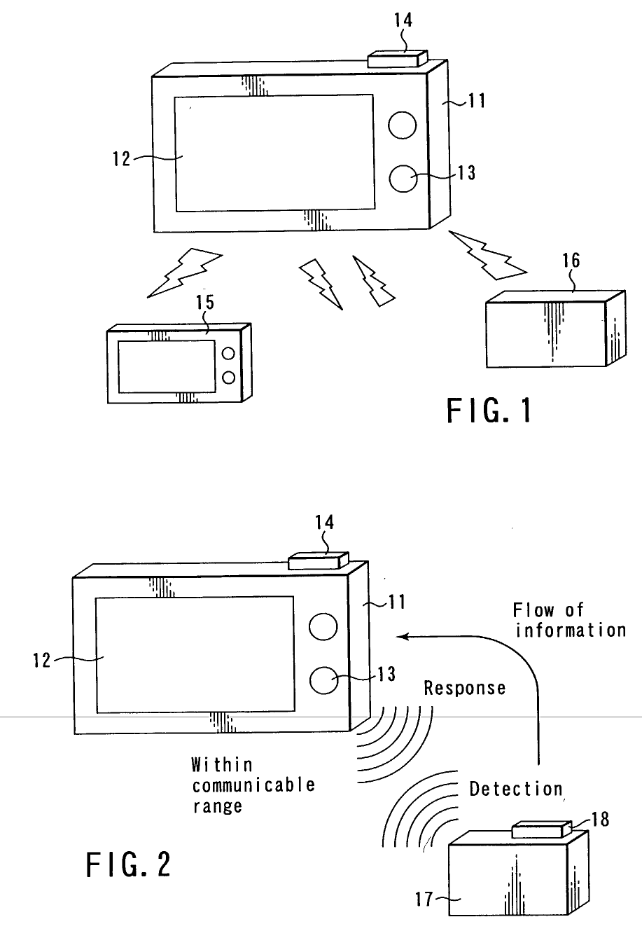

FIG. 1 is a view for illustrating wireless communication between an information device according to one embodiment of the present invention, and another devices.

As the information device, various types of devices such as a portable information terminal or headphone type music playback device can be used, but in FIG. 1, a case where the information device according to one embodiment of the present invention is a portable information terminal is shown.

A portable information terminal 11 shown in FIG. 1 includes a display device (such as LCD) 12 to display information and an input device (user interface) 13 which is used by the user to perform an input operation and a short-range wireless communication device 14 conforming to Bluetooth™ is mounted thereon.

The portable information terminal 11 can make information exchange with respect to the same type of portable information terminals 15 which lie in a communicable range via the short-range wireless communication device 14 and can also make information exchange with respect to another device 16 if it has a short-range wireless communication device conforming to Bluetooth™. Particularly, in the present embodiment, it is possible to make reception by the push (insertion) type operation in the short-range wireless communication device 14 of the portable information terminal 11 and acquire information (contents) from an external device without the operation of the user.

In this case, the short-range wireless communication device 14 mounted on the portable information terminal 11 can be formed to be contained in the portable information terminal 11 or it can be realized in the form of a PC card or SD card and inserted into the card slot of the portable information terminal 11 from the exterior.

FIG. 2 is a view for illustrating push-type information distribution with respect to the information device (portable information terminal 11). In FIG. 2, portions which are common to those of FIG. 1 are denoted by the same reference symbols.

In order to perform the push-type information distribution, an information terminal 17 having a short-range wireless communication device 18 conforming to Bluetooth™ is installed at a preset location. The information terminal 17 (or the short-range wireless communication device 18 thereof) is operated according to the protocol of Bluetooth™ and searches for a device which comes into a radio wave effective range and can make information exchange.

If the information terminal 17 (or the short-range wireless communication device 18 thereof) detects the presence of the portable information terminal 11 (or the short-range wireless communication device 14 thereof), it attempts to make connection with the portable information terminal 11. In this case, if no rejection is issued from the portable information terminal 11, the information terminal 17 can send information (for example, direct mail or news headlines) which is desired to be transmitted to the portable information terminal 11 by pushing (inserting) the above information with respect to the portable information terminal 11.

If every reception of push-type information is admitted on the portable information terminal 11 side, there may occur a problem that information will flow into the portable information terminal 11 endlessly. On the other hand, if reception of push-type information is not admitted, the advantage of push-type information reception (for example, the newest information or effective information that can be stored irrespective of whether or not the user is aware of it) will be lost. Therefore, in the present embodiment, the following two communication modes are prepared on the portable information terminal 11 side in order to solve a problem that information will flow into the internal portion of the portable information terminal 11 endlessly and make good use of the advantage of push-type information reception. In this case, switching between the following two communication modes can be made in-one operation of the user, thereby obtaining the convenient and pleasant environment for the user.

Communication mode (first communication mode) in which push requests (access requests) of information from arbitrary devices existing within a communicable range are all accepted.

Communication mode (second communication mode) in which only push requests (access requests) of information from devices having specified identification information previously registered by the user are accepted, whereas push requests from other devices are rejected (i.e., connection is rejected).

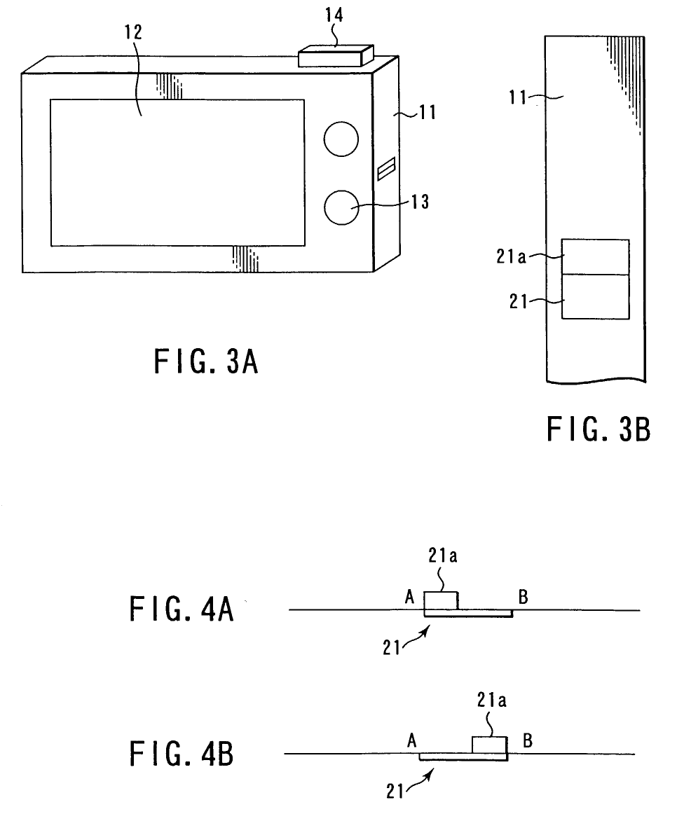

FIGS. 3A and 3B are views for illustrating one example (slide switch) of a communication mode switching mechanism to make switching between the first and second switching modes in the information device (portable information terminal 11).

As shown in FIGS. 3A and 3B, as the communication mode switching mechanism (hardware) which permits the user to make switching between the first and second switching modes in one operation, a slide switch 21 is disposed on a portion (such as the side surface) of the portable information terminal 11 where the operation can be easily performed. The slide switch 21 is provided with a member 21a. The user bi-directionally slides the member 21a by use of his or her finger to instantly make switching between the first and second switching modes.

FIGS. 4A and 4B are views showing two states into which the slide switch 21 can be set,

As shown in FIG. 4A, when the member 21a of the slide switch 21 is set at a point A by the user, a state in which the second communication mode is set can be set up. On the other hand, as shown in FIG. 4B, when the member 21a of the slide switch 21 is set at a point B by the user, a state in which the first communication mode is set can be set up.

The user sets the member 21a at the point A in the normal condition to set up the state in which the second communication mode is set. In this state, it is possible to prevent unnecessary information from flowing from a device other than the device having previously registered identification information. If it becomes necessary to acquire information from a device (such as an information sales terminal disposed in a public place, for example, in front of a store) in which identification information is not registered, the user slides the member 21a to the position of the point B so as to set up the state in which the second communication mode is set. Thus, desired information can be acquired.

According to the above mechanism, it is unnecessary for the user to keep contact with the member 21a while information is being downloaded from the information sales terminal or the like. Therefore, the advantage that the load of the user is alleviated can be attained and this is effective when the downloading operation is performed for a relatively long period of time.

Instead of the above mechanism, it is possible to use a mechanism which sets up a state in which the second communication mode is set by positioning the member 21a at the point A by the action of a spring or the like when the user does not make contact with the member 21a. Further, the mechanism sets up a state in which the first communication mode is set by continuously depressing the member 21a in the position of the point B against the force of the spring only when it becomes necessary to acquire information from a device in which identification information is not registered. In this case, there is no possibility that the user will forget to restore the state of the switch to the original position after information has been downloaded from the information sales terminal or the like and it is effective when the downloading operation is performed in a relatively short period of time.

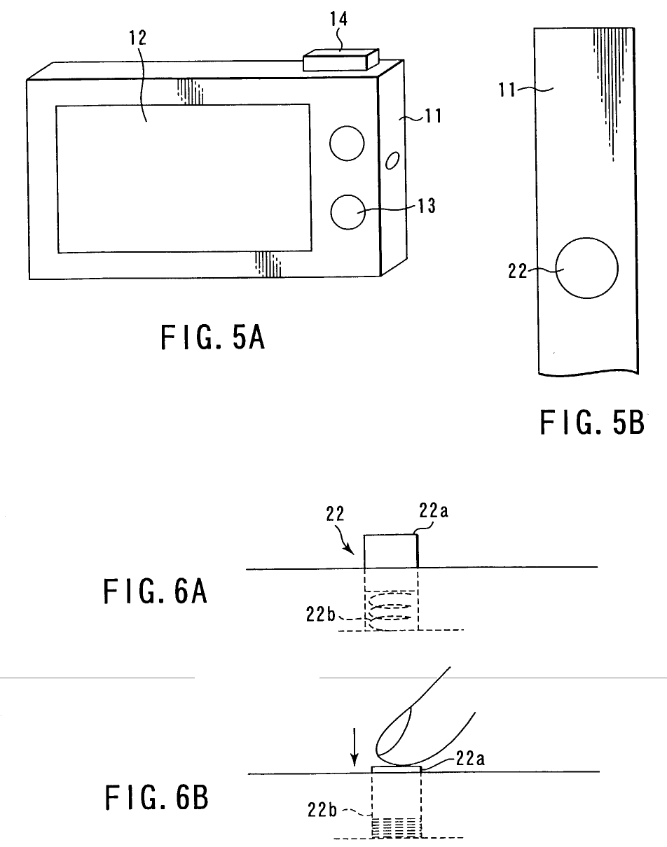

FIGS. 5A and 5B are views for illustrating another example (button switch) of the communication mode switching mechanism which is used to make switching between the first and second switching modes in the information device (portable information terminal 11).

As shown in FIGS. 5A and 5B, as the communication mode switching mechanism (hardware) which permits the user to make switching between the first and second switching modes in one operation, a button switch 22 is disposed on a portion (such as the side surface) of the portable information terminal 11 where the operation can be easily performed. The button switch 22 is provided with a member 22a. The user performs the depressing operation/releasing operation with respect to the member 22a by use of, for example, his or her finger so as to instantly make switching between the first and second switching modes.

FIGS. 6A and 6B are views showing two states into which the button switch 22 can be set,

As shown in FIG. 6A, when the member 22a of the button switch 22 is set in the upper position by the action of a spring 22b when the user does not make contact with the button switch. At this time, a state in which the second communication mode is set can be set up. On the other hand, as shown in FIG. 6B, when the member 22a of the button switch 22 is depressed by the user, the spring 22b is compressed and the member 22a is positioned in the lower position. At this time, a state in which the first communication mode is set can be set up.

Since the user does not make contact with the member 22a in the normal condition, the state in which the second communication mode is set can be set up and it is possible to prevent unnecessary information from flowing from a device other than the device having previously registered identification information. If it becomes necessary to acquire information from a device (such as an information sales terminal disposed in a public place, for example, in front of a store) in which identification information is not registered, the first communication mode is set by continuously depressing the member 22a while the information is being transferred, and thus, desired information can be acquired.

According to the above mechanism, there is no possibility that the user will forget to restore the state of the switch to the original position after information has been downloaded from the information sales terminal or the like and it is effective when the downloading operation is performed in a relatively short period of time.

Instead of the above mechanism, it is possible to use a mechanism which repeatedly and alternately sets the first communication mode in which the member 22a is set in the lower position and the second communication mode in which the member 22a is set in the upper position each time the depressing operation/releasing operation is performed. In this case, it is unnecessary for the user to keep contact with the member 22a while information is being downloaded from the information sales terminal or the like. Therefore, the advantage that the load of the user is alleviated can be attained and this is effective when the downloading operation is performed for a relatively long period of time.

In the explanation with reference to FIGS. 1 to 6B, a case where the information device according to the present embodiment is the portable information terminal 11 is explained, but as will be described below, it is possible to realize the information device as a headphone type music playback device. Also, in this case, a communication mode switching mechanism which makes switching between the first and second communication modes as described above can be used.

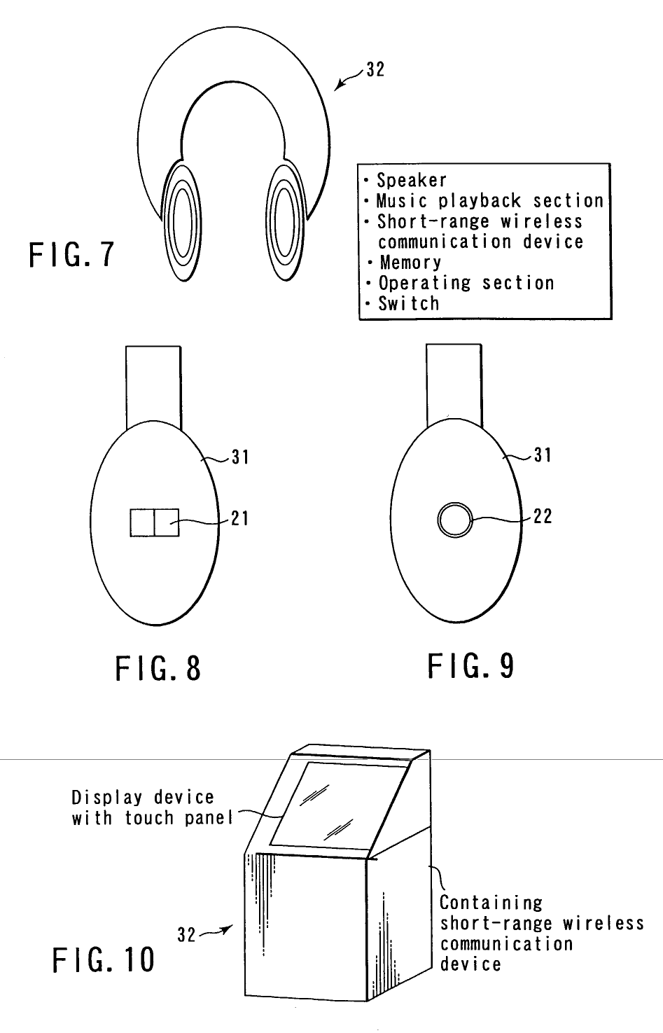

FIG. 7 is a view for illustrating an example in which the information device according to the present embodiment is a headphone type music playback device.

A portable music playback device 31 having a function of playing back music is configured in the form of a headphone or earphone as shown in FIG. 7 and includes a speaker, music playback section, short-range wireless communication device, memory, operating section, switch (communication mode switching mechanism) and the like which will be described in detail later.

The music playback device 31 has such a configuration that the user can play back and enjoy music with the music playback device 31 mounted on the user's head. Further, when a musical composition (i.e., music data) is downloaded from another device which has the musical composition stored therein to the music playback device 31, the short-range wireless communication device is used.

FIG. 8 is a view for illustrating one example (slide switch) of the communication mode switching mechanism which is used to make switching between the first and second switching modes in the information device (music playback device 31).

As shown in FIG. 8, as the communication mode switching mechanism (hardware) which permits the user to make switching between the first and second switching modes in one operation, a slide switch 21 (which is the same as the switch shown in FIGS. 3B, 4A, 4B) is disposed on a portion (such as the ear-pad portion) of the music playback device 31 where the operation can be easily performed. The detail of the slide switch 21 is the same as described before and the explanation thereof is omitted here.

FIG. 9 is a view for illustrating another example (button switch) of the communication mode switching mechanism which is used to make switching between the first and second switching modes in the information device (music playback device 31).

As shown in FIG. 9, as the communication mode switching mechanism (hardware) which permits the user to make switching between the first and second switching modes in one operation, a button switch 22 (which is the same as the switch shown in FIGS. 5B, 6A, 6B) is disposed on a portion (such as the ear-pad portion) of the music playback device 31 where the operation can be easily performed. The detail of the button switch 22 is the same as described before and the explanation thereof is omitted here.

FIG. 10 is a view showing a musical composition sales terminal (music data distribution device) 32 which distributes musical compositions (i.e., music data) to the music playback device 31 or the like.

The musical composition sales terminal 32 is a terminal which is installed in a public place, for example, in front of a store and is designed mainly to sell musical compositions. As will be described later, the musical composition sales terminal 32 contains a short-range wireless communication device and a display device with touch panel. It is so configured as to display information for the user, permit the input operation to be performed by use of the touch panel and transmit the guidance and musical compositions to the music playback device 31 or the like via the short-range wireless communication device.

The musical composition sales terminal 32 always searches for a device having the same type of short-range wireless communication device and, for example, if it detects the music playback device 31, the musical composition sales terminal 32 urges the user of the music playback device 31 to utilize the musical composition sales terminal 32. The above operation can be said to be one type of push-type communication. At this time, the musical composition sales terminal 32 sends information in a voice to the music playback device 31. However, it is considered that the user of the music playback device 31 has no interest at that time and desires to not use the musical composition sales terminal 32. In the present embodiment, such a case is taken into consideration. That is, occurrence of an interruption by the musical composition sales terminal 32 while the user is enjoying playback of the musical composition can be prevented by previously setting the second communication mode in which an access request from an unspecified device is interrupted by use of the communication mode selection switch 21 (FIG. 8) or communication mode selection switch 22 (FIG. 9).

Further, in a case where the user desires to utilize the musical composition sales terminal 32, the first communication mode in which an access request from an unspecified device is accepted is set. Then, the user makes an access to the musical composition sales terminal 32 and utilization guidance will be sent to the device of the user so as to simplify the succeeding musical composition purchasing operation.

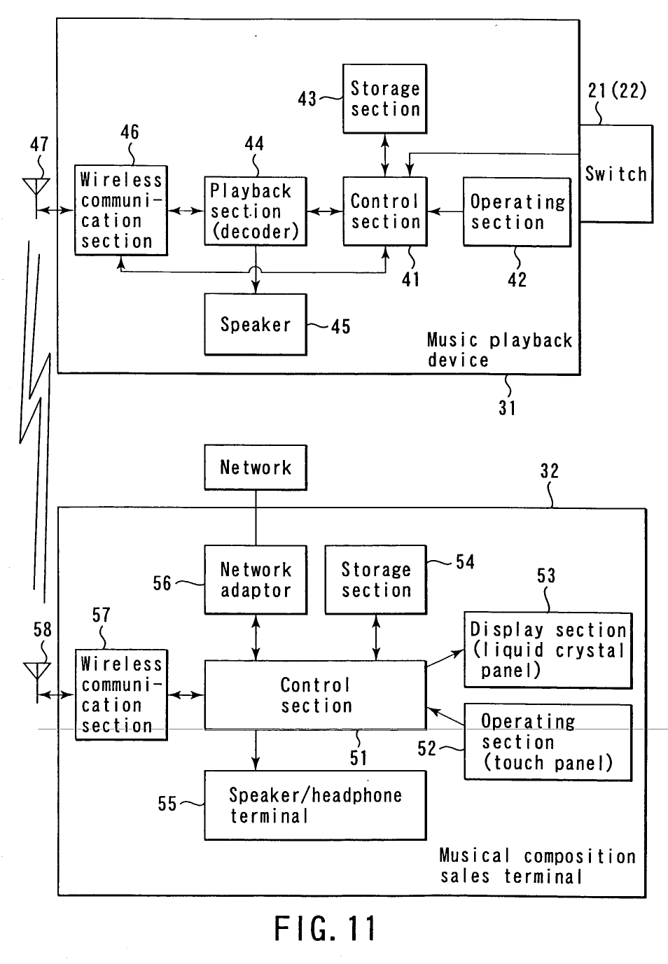

FIG. 11 is a block diagram showing the configuration of the music playback device 31 and musical composition sales terminal 32.

The music playback device 31 includes a control section 41, operating section 42, storage section (internal/external memory) 43, playback section (decoder) 44, speaker 45, wireless communication section 46, antenna 47, switch 21 (or 22) and the like.

The control section 41 is a section which controls the whole operation of the music playback device 31 and performs processes associated with various control operations.

For example, the control section 41 executes a preset control program to perform the switch control operation with respect to the wireless communication section 46 so as to set one of the first and second communication modes in accordance with the switching operation of the switch 21 (or 22) by the user.

Further, the control section 41 may perform the control operation so as not to switch the communication mode even if the switch 21 (or 22) is operated while information distribution from another device is being performed in the first communication mode.

Also, while information distribution from another device is being performed in the first communication mode, the control section 41 may perform the control operation so as not to respond to an information distribution request even if the information distribution request is issued from still another device.

Further, the control section 41 may perform the control operation so as to make switching from the first communication mode to the second communication mode even if the switch 21 (or 22) is not operated after information distribution from another device in the first communication mode is completed.

The operating section 42 is a section which is operated by the owner of the music playback device 31 and used when the operation associated with the playback process, recording process, wireless communication process or the like is performed. Further, the user can register onto the storage section 43 an identification code of a device which is to accept a push request (access request) when the second communication mode is set by use of the operating section 42.

The storage section 43 is a section which stores or records data such as musical compositions (music) in a preset form. Further, the storage section 43 stores an identification code of a device which is to accept a push request (access request) when the second communication mode is set and the contents thereof are referred to by the control section 41.

The playback section 44 is a section which performs the playback process (decoding process) for voice information such as musical compositions stored in the storage section 43.

The speaker 45 is a section which outputs a voice played back by the playback process of the playback section 44.

The wireless communication section 46 is a section corresponding to a wireless communication interface conforming of Bluetooth™ and performs various setting processes and control processes associated with the short-range wireless communication.

The antenna 47 is a section which transmits radio waves to a device at the destination of wireless communication and receives radio waves from the device.

The musical composition sales terminal 32 includes a control section 51, operating section (touch panel) 52, display section (liquid crystal panel) 53, storage section 54, speaker (or headphone terminal) 55, network adaptor 56, wireless communication section 57, antenna 58 and the like.

The control section 51 is a section which controls the whole portion of the musical composition sales terminal 32 and performs processes associated with various control operations.

The operating section 52 is a section which is operated by the user (for example, the owner of the music playback device 31) of the musical composition sales terminal 32 by use of the touch panel (or cursor key) and used when the operation associated with the guidance or musical composition purchasing operation is performed.

The display section 53 has a liquid crystal panel and provides various services and guidance associated with musical compositions by, for example, displaying items which are used to individually identify music playback devices within the communication range of the musical composition sales terminal 32 on the screen and giving guidance which indicates how to purchase a musical composition.

The storage section 54 is a section which stores guidance information and musical composition information.

The speaker (or headphone terminal) 55 is a section which outputs guidance information and musical composition information as a voice to the user.

The network adaptor 56 is a section which controls transfer of information with respect to an external network. For example, the network adaptor 56 acquires musical composition information or the like previously stored via a network as required.

The wireless communication section 57 is a section corresponding to a wireless communication interface conforming to Bluetooth™ and performs various setting processes and control processes associated with the short-range wireless communication.

The antenna 58 is a section which transmits radio waves to a device at the destination of wireless communication and receives radio waves from the device.

A musical composition is provided to the user from the storage section 54 which the musical composition sales terminal 32 itself has or from an external server via a network.

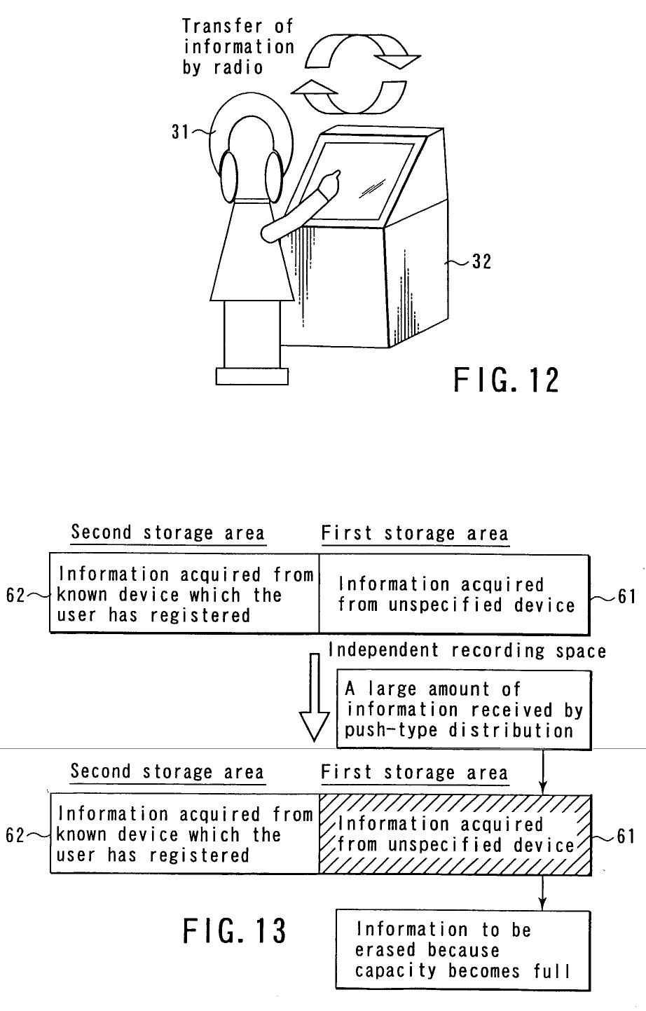

FIG. 12 is a view showing a state in which the owner of the music playback device 31 performs an operation for purchasing a musical composition with respect to the musical composition sales terminal 32.

The user (in this example, the owner of the music playback device 31) of the musical composition sales terminal 32 performs an operation for purchasing a musical composition with respect to the musical composition sales terminal 32 with the music playback device 31 set on his or her head as shown in FIG. 12 and takes a desired musical composition into his or her own music playback device 31. In this case, the operation for fetching the musical composition from the musical composition sales terminal 32 into the music playback device 31 is performed via the short-range wireless communication device (wireless communication section 57, antenna 58) provided in the musical composition sales terminal 32 and the short-range wireless communication device (wireless communication section 46, antenna 47) provided in the music playback device 31.

Information acquired by the information device such as the music playback device 31 from another device via the short-range wireless communication device is stored into a preset storage area of the storage section, but information which is contained in the above information and is important for the user is not necessarily kept un-erased and held in the storage area. Therefore, a method for securely protecting such information is explained below.

FIG. 13 is a diagram for illustrating a recording space used to record information which the information device such as the portable information terminal 11 or music playback device 31 acquires from another device.

As shown in FIG. 13, in the storage section of the information device (for example, the storage section 43 of the music playback device 31 (FIG. 11)), a first storage area 61 to record information (information acquired in the first communication mode) acquired from unspecified devices and a second storage area 62 to record information (information acquired in the second communication mode) acquired from specified devices registered by the user are independently managed.

When the information device receives a large amount of information by push-type distribution from an unspecified device (when reception is made in the first communication mode), the information is stored in the first storage area 61. At this time, if the capacity of the first storage area 61 becomes full and reaches the upper limit, information is automatically erased in order from the oldest information. However, since information in the first storage area 61 is information acquired by push-type distribution from unspecified devices and is not particularly important for the user, there occurs no problem even if it is erased.

On the other hand, when the information device receives information from a specified device registered by the user (when reception is made in the second communication mode), the information is stored in the second storage area 62. Information stored in the second storage area 62 is relatively important for the user and since a large amount of information from an unspecified device does not flow into the second storage area 62, the storage capacity thereof will not instantly become full. If the storage capacity becomes full and information is required to be erased, the control section performs a process for obtaining user's confirmation. Therefore, information in the second storage area 62 will not be erased without user's permission.

Thus, information which is important for the user can be safely protected and the storage capacity can be prevented from instantly reaching the upper limit by separately managing the first storage area 61 to record information (information acquired in the first communication mode) acquired from an unspecified device and the second storage area 62 to record information (information acquired in the second communication mode) acquired from a known device previously registered by the user.

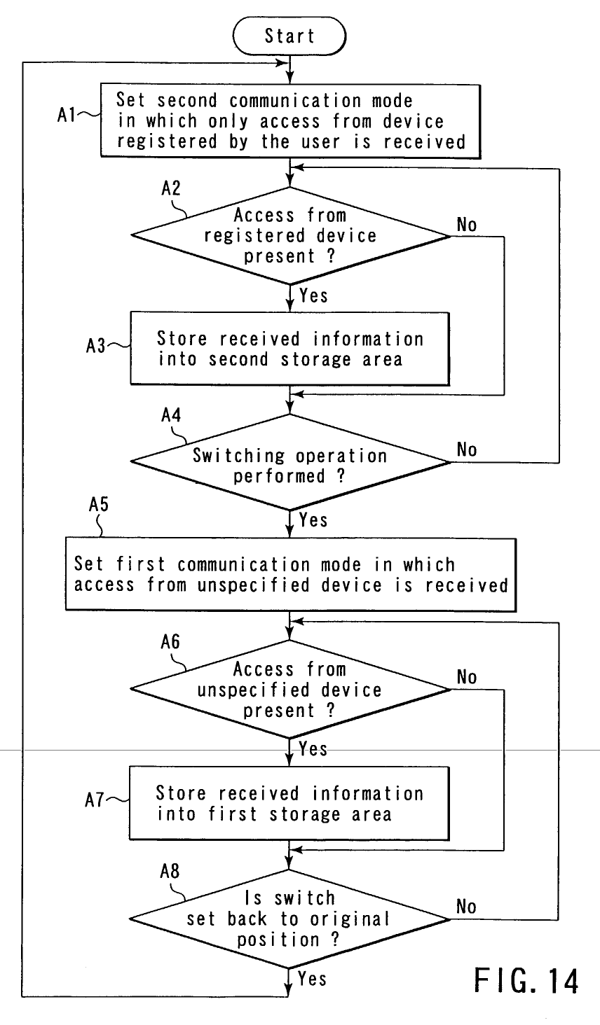

Next, the operation of the information device is explained with reference to the flowchart of FIG. 14.

When the information device (portable information terminal 11 or music playback device 31) is used, the information device is set in the second communication mode by use of a switch (step A1) so as to set up a state in which only an access request from a device previously registered by the user is received as an initial condition.

Whether an access request from a device previously registered by the user is detected or not is monitored in a state in which the second communication mode is set (step A2). If an access request from a device previously registered by the user is detected, the access request is accepted and information received at this time is stored into the second storage area 62 (step A3).

Further, whether the switch operation is performed by the user or not is monitored (step A4). If the switch operation is performed by the user, the mode is switched from the second communication mode to the first communication mode in which an access request from an unspecified device is received and thus the first communication mode is set (step A5).

Whether an access request from an unspecified device is detected or not is monitored (step A6) in the state in which the first communication mode is set. If an access request from an unspecified device is detected, the access request is received and information received at this time is stored into the first storage area 61 (step A7).

Further, whether the switch operation (the operation for returning the switch state to the original position) is performed by the user or not is monitored (step A8). If the switch operation by the user is detected, the process returns to the step A1. That is, the mode is switched from the first communication mode which is now set to the second communication mode, thus the second communication mode is set and the succeeding process is performed.

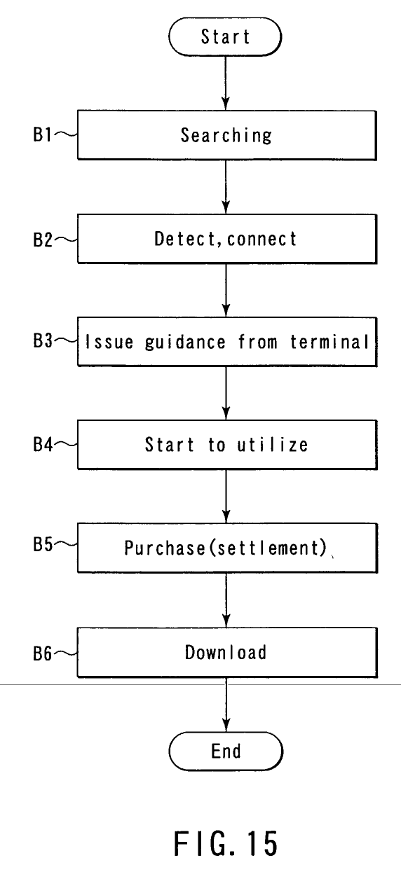

Next, the operation performed when a musical composition is purchased from the musical composition sales terminal 32 by use of the music playback device 31 is explained with reference to the flowchart shown in FIG. 15.

The musical composition sales terminal 32 searches for a device (in this example, the music playback device 31) having a short-range wireless communication device of the same type and located around the musical composition sales terminal 32 (located within a connectable and communicable range thereof) via a short-range wireless communication device (step B1).

In this case, if the user wearing the music playback device 31 comes closer to the musical composition sales terminal 32 while the first communication mode is set by use of the switch on the music playback device 31 side, the musical composition sales terminal 32 detects arrival of the music playback device 31 into the range thereof (or detects the music playback device 31). Then, the musical composition sales terminal 32 attempts to make connection with the music playback device 31 of the user via the short-range wireless communication device (step B2).

If the connection is successfully made, the musical composition sales terminal 32 generates an interruption to the music playback device 31 and transmits a voice or music for guidance (step B3). Thus, push-type guidance by the musical composition sales terminal 32 is provided for the owner and the user can obtain the guidance.

The user becomes aware of the presence of the musical composition sales terminal 32 and starts the operation thereof (step B4).

The voice and music generated at the operation time can be heard on the music playback device 31 worn on the user via the short-range wireless communication device. The user performs the operation on the musical composition sales terminal 32, determines to purchase the musical composition, performs an accounts settling procedure if the musical composition is distributed with cost (step B5) and acquires musical composition data by downloading (step B6).

As described above, according to the present embodiment, the user can prevent unnecessary information from being received without performing the special operation by setting the communication mode selection switch in the second communication mode in which only information distributed from devices having identification information previously registered by the user in the information device is received in the normal state.

If it is desired to receive distributed information from a device having identification information which is not registered by the user, desired distributed information can be easily received when necessary since the first communication mode in which distributed information from an unspecified device is received can be set by performing a simple switching operation for the communication mode selection switch.

That is, an information device which is convenient for the user can be realized by using two types of communication modes instead of fixedly using one communication mode and providing a mechanism which can make switching between the above communication modes in one operation.

Further, information stored in the second storage area can be particularly safely protected by providing the first storage area to store information distributed from an unspecified device and providing the second storage area to store information distributed from a device having identification information previously registered by the user as an independent storage area different from the first storage area.

The present invention is not limited to the above embodiment and can be variously modified without departing from the technical scope thereof.

For example, in the above embodiment, a case where Bluetooth™ is used as the short-range wireless communication technology is explained, but it is also possible to use another short-range wireless communication technology such as wireless LAN. Further, push-type distributed information (contents) is not limited to music information such as a musical composition and image information (video information) such as a moving picture or still picture can be used.

As described above, according to the present invention, an information device and information distribution system which can efficiently receive information distributed from another devices, and a communication mode switching method, information storage method and information distribution method applied thereto can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information device for receiving information distributed from devices via a communication device, comprising:
a communication mode selection switch configured to allow switching between a first communication mode for receiving an information distribution request from an arbitrary device and a second communication mode for receiving an information distribution request from a device having specified identification information; and
a control unit configured to perform a switching control to set one of the first and second communication modes in accordance with a switching operation of the communication mode selection switch.

2. The information device according to claim 1, wherein the communication mode selection switch includes a slide switch.

3. The information device according to claim 1, wherein the communication mode selection switch includes a button switch.

4. The information device according to claim 3, wherein the first communication mode is set while the button switch is kept depressed and the second communication mode is set while the button switch is not kept depressed.

5. The information device according to claim 1, wherein the second communication mode is set while the communication mode selection switch is not operated.

6. The information device according to claim 1, wherein the control unit performs a control operation to keep the communication mode unchanged while information distribution from a device in the first communication mode is being made even if the communication mode selection switch is operated.

7. The information device according to claim 1, wherein the control unit performs a control operation to ignore an information distribution request from a device while information distribution from another device in the first communication mode is being made.

8. The information device according to claim 1, wherein the control unit performs a control operation to make switching from the first communication mode to the second communication mode after information distribution from a device in the first communication mode is completed even if the communication mode selection switch is not operated.

9. The information device according to claim 1, further comprising a storage unit including a first storage area to store information distributed from an unspecified device and a second storage area which is different from the first storage area and stores information distributed from a specified device having identification information registered in the information device.

10. The information device according to claim 9, wherein information stored in the second storage area is not erased without permission.

11. An information distribution system comprising:
an information distribution device configured to perform information distribution; and
an information device configured to receive information distributed from the information distribution device via a communication device, the information device including
a communication mode selection switch configured to allow switching between a first communication mode for receiving an information distribution request from an arbitrary device and a second communication mode for receiving an information distribution request from a device having specified identification information, and
a control unit configured to perform a switching control to set one of the first and second communication modes in accordance with a switching operation of the communication mode selection switch.

12. The information distribution system according to claim 11, wherein the information distribution device includes a music data distribution device configured to distribute music data to the information device, and the information device includes a music playback device configured to play back the music data.

13. A communication mode switching method applied to an information device for receiving information distributed from devices via a communication device, comprising:
allowing a switching operation between a first communication mode for receiving an information distribution request from an arbitrary device and a second communication mode for receiving an information distribution request from a device having a specified identification information, via a communication mode selection switch; and
setting one of the first and second communication modes in accordance with a switching operation of the communication mode selection switch.

14. An information distribution method applied to a system in which an information device receives information distributed from an information distribution device via a communication device, comprising:
allowing a switching operation between a first communication mode for receiving an information distribution request from an arbitrary device and a second communication mode for receiving an information distribution request from a device having a specified identification information, via a communication mode selection switch, on the information device; and
performing information distribution from the information distribution device to the information device while the first communication mode is set by use of the communication mode selection switch.

15. An information device for receiving information distributed from devices via a communication device, comprising:
a communication mode selection switch configured to allow switching between a plurality of communication modes for receiving information distribution requests, one of the plurality of communication modes being a mode for receiving an information distribution request from a device having specified identification information; and
a control unit configured to perform a switching control to set one of the plurality of communication modes in accordance with a switching operation of the communication mode selection switch.

16. A communication mode switching method applied to an information device for receiving information distributed from devices via a communication device, comprising:
allowing a switching operation between a plurality of communication modes for receiving information distribution requests, one of the plurality of communication modes being a mode for receiving an information distribution request from a device having a specified identification information, via a communication mode selection switch; and
setting one of the plurality of communication modes in accordance with a switching operation of the communication mode selection switch.
